(19) United States
(12) Patent Application Publication
(10) Pub. No.: US 2023/0204249 A1
(43) Pub. Date: Jun. 29, 2023

(54) HUMIDIFYING APPARATUS AND DOMESTIC APPLIANCE

(71) Applicant: SAMSUNG ELECTRONICS CO., LTD., Suwon-si (KR)

(72) Inventors: Hyunah KIM, Suwon-si (KR); Seonuk NA, Suwon-si (KR); Joonhyoung KIM, Suwon-si (KR); Hyojin KIM, Suwon-si (KR); Youngchal PARK, Suwon-si (KR); Hyeongjoon SEO, Suwon-si (KR); Youngtae SONG, Suwon-si (KR); Dongho CHO, Suwon-si (KR); Sungjune CHO, Suwon-si (KR)

(73) Assignee: SAMSUNG ELECTRONICS CO., LTD., Suwon-si (KR)

(21) Appl. No.: 17/994,679

(22) Filed: Nov. 28, 2022

Related U.S. Application Data
(63) Continuation of application No. PCT/KR2022/017808, filed on Nov. 11, 2022.

(30) Foreign Application Priority Data
Dec. 29, 2021 (KR) 10-2021-0190578

(51) Int. Cl. F24F 13/08; F24F 6/02; F24F 13/20; F24F 13/24; B01F 23/10; B01F 23/70

(52) U.S. Cl. CPC F24F 13/08; F24F 6/025; F24F 13/20; F24F 13/24; B01F 23/12; B01F 23/711; F24F 2006/008

(57) ABSTRACT

A humidifying apparatus includes a water tank provided to hold water, a heating device configured to heat the water held in the water tank, a discharge chamber disposed above the water tank and including an outlet configured to discharge steam generated in the water tank due to the water being heated, a guide chamber between the water tank and the discharge chamber configured to guide the steam generated in the water tank into the discharge chamber, and a screen at a central portion of the guide chamber and spaced apart from an inner sidewall of the guide chamber to form a gap between the screen and the inner sidewall, so that the screen interferes with a flow of the steam guided by the guide chamber and allows the steam to flow through the gap to then be guided by the guide chamber into the discharge chamber.

### CROSS-REFERENCE TO RELATED APPLICATION

This application is a continuation of International Application PCT/KR2022/017808, filed Nov. 11, 2022, and is based on and claims priority under 35 U.S.C. § 119 to Korean Patent Application No. 10-2021-0190578, filed on Dec. 29, 2021 in the Korean Intellectual Property Office, the disclosures of which are incorporated herein by reference in their entireties.

### BACKGROUND

### 1. Field

Embodiments of the present disclosure relate to a humidifying apparatus and domestic appliance with an improved structure.

### 2. Description of the Related Art

A humidifying apparatus refers to an apparatus that vaporizes water to control indoor humidity. The humidifying apparatus is used to maintain indoor humidity at an appropriate level and prevent various respiratory diseases.

Examples of the humidifying apparatus may include an ultrasonic humidifying apparatus that vaporizes water using ultrasonic waves, a heating-type humidifying apparatus that vaporizes water by heating the water, and a vaporizing-type humidifying apparatus that performs humidification through natural evaporation.

In the case of the heating-type humidifying apparatus, a high-temperature steam may be discharged due to heating the water. Here, in a case in which the user is directly exposed to the high-temperature steam, the user may get burned. Also, a water boiling noise may occur during use of the humidifying apparatus.

Meanwhile, mineral components, organic matter, and the like contained in water may be deposited as scale and sediment and get stuck inside the humidifying apparatus. When the stuck scale and sediment are left unremoved, the humidifying apparatus may be discolored, or odor may be generated from the humidifying apparatus.

### SUMMARY

Aspects of the disclosure will be set forth in part in the description which follows and, in part, will be obvious from the description, or may be learned by practice of the disclosure.

In accordance with one aspect of the present disclosure, a humidifying apparatus includes a water tank configured to hold water; a heating device configured to heat the water held in the water tank; a discharge chamber disposed above the water tank and including an outlet configured to discharge steam generated in the water tank due to the water being heated by the heating device; a guide chamber between the water tank and the discharge chamber and configured to guide the steam generated in the water tank into the discharge chamber; and a screen at a central portion of an inside of the guide chamber and spaced apart from an inner sidewall of the guide chamber to form a gap between the screen and the inner sidewall, so that the screen interferes with a flow of the steam guided by the guide chamber in the central portion and allows the steam guided by the guide chamber to flow through the gap and to then be guided by the guide chamber into the discharge chamber.

The humidifying apparatus may further include a lower plate inside the guide chamber disposed below and spaced apart from the screen and including a through-hole in a central portion of the lower plate so that the steam guided by the guide chamber passes through the through-hole and then into the gap.

The humidifying apparatus may further include an upper plate inside the guide chamber disposed above and spaced apart from the screen and including a through-hole in a central portion of the upper plate so that the steam, after flowing through the gap, is guided by the upper plate to flow through the through-hole and then into the discharge chamber.

The humidifying apparatus may further include a blower fan including a suction portion configured to suction outside air and a discharge portion communicating with the discharge chamber to deliver the outside air suctioned by the suction portion to the discharge chamber.

The discharge chamber may further include a base detachably coupled to an upper portion of the guide chamber; and a mixing tower extending from the base in a direction in which the steam flows and that is configured to mix the steam introduced from the guide chamber and the outside air introduced from the blower fan.

The screen may be inclined downward and away from the central portion of the guide chamber so that condensed water from the steam flowing inside the guide chamber is guided downward and away from the discharge chamber.

The lower plate may be inclined downward and toward the through-hole so that condensed water from the steam flowing inside the guide chamber is guided downward by the lower plate and away from the discharge chamber.

The upper plate may be inclined downward and toward the through-hole so that condensed water from the steam flowing inside the guide chamber is guided downward by the upper plate and away from the discharge chamber.

The blower fan may be configured to turn off after passage of a predetermined amount of time after a humidifying operation by the humidifying apparatus ends.

The blower fan may further include a first blower fan and a second blower fan, and the mixing tower of the discharge chamber may be disposed between the first blower fan and the second blower fan.

The humidifying apparatus may further include a perforated plate disposed between the guide chamber and the water tank so that noise generated when the heating device heats the water held in the water tank is attenuated.

The size of an internal cross-sectional area of the guide chamber in a direction in which the steam flows may be non-uniform so that a pressure of the steam that is guided through the guide chamber is changed relative to a previous pressure of the steam.

The humidifying apparatus may further include a first plate disposed below and spaced apart from the screen inside the guide chamber and including a first through-hole in a central portion of the first plate; and a second plate disposed above and spaced apart from the screen inside the guide chamber and including a second through-hole in a central portion of the second plate, and the guide chamber may further include: a first guide chamber portion detachably coupled to an upper side of the water tank that includes the first plate, the screen, and a connecting rib configured to connect the first plate to the screen, and a second guide chamber portion detachably coupled to an upper side of the first guide chamber portion to communicate with the discharge chamber and that includes the second plate.

The water tank may include a bottom and a sidewall extending upward from the bottom, and the heating device may be disposed on the sidewall of the water tank.

The humidifying apparatus may further include a supply pump connected to the water tank to supply water to the water tank and a drain pump connected to the water tank to drain the water held in the water tank.

In accordance with another aspect of the present disclosure, a humidifying apparatus includes a water tank provided to accommodate water, a heater provided to heat the water and generate steam, a blower fan provided to force outside air to flow, and a mixing chamber disposed above the water tank, wherein the mixing chamber includes a base provided to have a lower side communicating with the water tank so that the steam is introduced from the water tank and an upper side communicating with the blower fan so that the outside air is introduced from the blower fan, a mixing tower extending upward from the base and provided to mix the steam and the outside air which are introduced into the base, and an outlet formed in an upper end portion of the mixing tower to discharge the steam mixed with the outside air.

The humidifying apparatus may further include a guide chamber disposed between the water tank and the mixing chamber and provided to guide the steam generated in the water tank to the mixing chamber.

The humidifying apparatus may further include a first plate disposed inside the guide chamber and including a first through-hole formed in a central portion, a screen disposed above and spaced apart from the first plate and provided to correspond to the first through-hole, and a second plate disposed above and spaced apart from the screen and including a second through-hole provided to correspond to the screen, and the steam generated in the water tank may be provided so that a direction thereof is changed due to the screen inside the guide chamber.

The first plate may include a concave shape to guide the water flowing inside the guide chamber to the first through-hole, the second plate may include a concave shape to guide the water flowing inside the guide chamber to the second through-hole, and the screen may include a convex shape to guide the water flowing inside the guide chamber downward.

In accordance with still another aspect of the present disclosure, a domestic appliance includes a main body, an outside air inlet formed in a lateral portion of the main body, a steam outlet formed in an upper portion of the main body, and a humidifying apparatus provided inside the main body to generate a steam, wherein the humidifying apparatus includes a water tank configured to accommodate water, a heater configured to heat the water in the water tank, a guide chamber provided so that the steam generated in the water tank flows therein, a screen disposed at a central portion inside the guide chamber to interfere with the flow of the steam, a blower fan provided to communicate with the outside air inlet to suction the outside air, and a mixing chamber provided to mix the steam introduced from the guide chamber and the outside air introduced from the blower fan and including an outlet disposed to correspond to the steam outlet to discharge the steam mixed with the outside air.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a front perspective view of a humidifying apparatus according to one embodiment;

FIG. 2 is a rear perspective view of the humidifying apparatus according to one embodiment;

FIG. 3 is an exploded view of the humidifying apparatus according to one embodiment;

FIG. 4 is an exploded view illustrating the humidifying apparatus illustrated in FIG. 3 from another direction;

FIG. 5 is a cross-sectional view of the humidifying apparatus according to one embodiment;

FIG. 6 is a view illustrating a portion cut out from the humidifying apparatus according to one embodiment;

FIG. 7 is an enlarged view of a portion of the humidifying apparatus illustrated in FIG. 5;

FIG. 8 is a control block diagram of the humidifying apparatus according to one embodiment;

FIG. 9 is a flowchart of an example of a method of controlling the humidifying apparatus according to one embodiment;

FIG. 10 is a perspective view of an example of an air cleaner including the humidifying apparatus according to one embodiment;

FIG. 11 is a rear perspective view of the air cleaner illustrated in FIG. 10; and

FIG. 12 is a cross-sectional view of the air cleaner illustrated in FIG. 10.

### DETAILED DESCRIPTION

Embodiments described herein and configurations illustrated in the drawings are merely exemplary embodiments of the present disclosure, and various modifications which may replace the embodiments and the drawings herein may be present.

Like reference numerals or symbols presented in the drawings of the application indicate parts or elements that perform substantially the same functions.

Terms used herein are for describing the embodiments and are not intended to limit and/or restrict the disclosure. A singular expression includes a plural expression unless context clearly indicates otherwise. In the application, terms such as “include” or “have” are for designating that features, numbers, steps, operations, elements, parts, or combinations thereof are present, and do not preclude the possibility of presence or addition of one or more other features, numbers, steps, operations, elements, parts, or combinations thereof in advance.

Throughout the application, when it is mentioned that a certain element is “connected” to another element, this not only includes a case in which the certain element is directly connected to the other element but also includes a case in which the certain element is indirectly connected to the other element via another element therebetween. Likewise, when it is mentioned that a certain element is “coupled” to another element, this not only includes a case in which the certain element is directly coupled to the other element but also includes a case in which the certain element is indirectly coupled to the other element via another element therebetween.

Throughout the application, when it is mentioned that a certain member is disposed “above” another member, this not only includes a case in which the certain member is in direct contact with the other member but also includes a case in which another member is present between the two members.

Terms including ordinals such as “first” and “second” used herein may be used to describe various elements, but the elements are not limited by the terms, and the terms are only used for the purpose of distinguishing one element from another element. For example, a first element may be referred to as a second element while not departing from the scope of the present disclosure, and likewise, a second element may also be referred to as a first element. The term “and/or” includes a combination of a plurality of related described items or any one item among the plurality of related described items.

Meanwhile, terms such as “front-rear direction,” “left-right direction,” “vertical direction,” “front,” “rear,” “above,” and “below” used in the following description are defined based on the drawings, and the shape and position of each element are not limited by the terms.

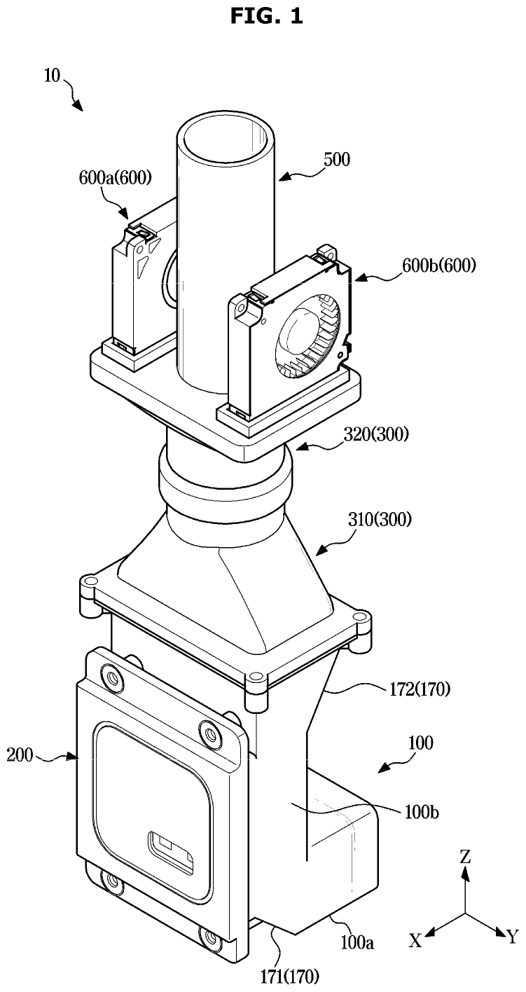

For example, as illustrated in FIG. 1, a direction toward a heating device 200 in a humidifying apparatus 10 may be defined as the front (+X direction), and a direction opposite thereto may be defined as the rear (−X direction). Also, for example, the X-direction may be referred to as the front-rear direction, the Y-direction may be referred to as the left-right direction, and the Z-direction may be referred to as the vertical direction. However, the X-direction, Y-direction, and Z-direction are only referred to as such based on the drawings for convenience of description and are not limited thereto.

It is an aspect of the present disclosure to provide a humidifying apparatus with improved use stability.

It is another aspect of the present disclosure to provide a humidifying apparatus with improved vaporization efficiency.

It is still another aspect of the present disclosure to provide a humidifying apparatus capable of preventing accumulation of sludge.

It is yet another aspect of the present disclosure to provide a humidifying apparatus with reduced noise.

Hereinafter, exemplary embodiments according to the present disclosure will be described in detail with reference to the accompanying drawings.

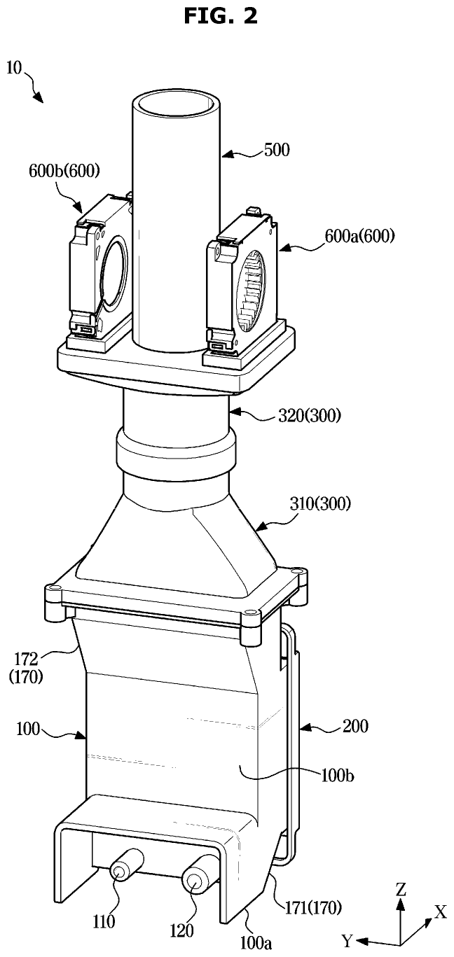

FIG. 1 is a front perspective view of a humidifying apparatus according to one embodiment. FIG. 2 is a rear perspective view of the humidifying apparatus according to one embodiment.

Referring to FIGS. 1 and 2, the humidifying apparatus 10 may include a water tank 100, the heating device 200, and a mixing chamber 500.

The water tank 100 may be provided to hold water.

The water tank 100 may include a supply port 110. The water tank 100 may receive water through the supply port 110. For example, a supply pump 180, which will be described below, may be connected to the supply port 110 of the water tank 100. The supply pump 180 may be provided to supply water from a water reservoir (not illustrated) to the water tank 100. However, the present disclosure is not limited thereto, and a user may directly fill the water tank 100 with water without using the supply port 110.

The water tank 100 may include a drain port 120. Water held in the water tank 100 may be drained through the drain port 120. For example, a drain pump 190, which will be described below, may be connected to the drain port 120 of the water tank 100. The drain pump 190 may be provided to drain the water accommodated in the water tank 100 out of the water tank 100. However, the present disclosure is not limited thereto, and a user may directly empty the water tank 100 without using the drain port 120.

For example, the water tank 100 may include a bottom 100a and a sidewall 100b extending upward from the bottom 100a. A top of the water tank 100 may be open. Although the water tank 100 is illustrated in the drawings as having a substantially box-like shape and including four sidewalls 100b, the present disclosure is not limited thereto, and the water tank 100 may be provided in various other shapes. For example, the water tank 100 may have a hollow, substantially cylindrical shape, and in this case, the sidewall 100b may be provided as a circumferential surface.

The heating device 200 may be provided to heat the water accommodated in the water tank 100. The heating device 200 may be provided to boil the water accommodated in the water tank 100. The heating device 200 may heat the water accommodated in the water tank 100 to generate steam.

The heating device 200 may be disposed on a lateral portion of the water tank 100. However, the present disclosure is not limited thereto, and the heating device 200 may be provided inside the water tank 100. The heating device 200 may be disposed in the water accommodated in the water tank 100. That is, the heating device 200 may heat the water tank 100 to indirectly heat water in the water tank 100 or directly heat the water in the water tank 100.

For example, the heating device 200 may be provided to not be disposed on the floor 100a of the water tank 100. The heating device 200 may be disposed on any sidewall 100b of the water tank 100 excluding the bottom 100a of the water tank 100. The heating device 200 may be disposed inside the water tank 100 excluding the bottom 100a of the water tank 100.

As the water in the water tank is heated, mineral components, organic matter, and the like contained in the water may be deposited as scale, sediment, foreign matter, and the like (hereinafter collectively referred to as “sludge”) and get stuck inside the water tank. The sludge may accumulate along a surface being heated, and it is necessary for a user to periodically remove the sludge. In a conventional case in which a bottom of a water tank is heated to generate steam, cleaning the water tank may not be easy due to sludge accumulating on the bottom of the water tank and getting stuck inside the water tank.

In contrast, according to one embodiment, since the heating device 200 is disposed on the lateral portion of the water tank 100 excluding the bottom 100a of the water tank 100 or disposed inside the water tank 100 excluding the bottom 100a of the water tank 100, sludge can be prevented from accumulating on the bottom 100a of the water tank 100 and getting stuck inside the water tank 100. Also, in the case in which the heating device 200 is disposed on the lateral portion of the water tank 100 excluding the bottom 100a or disposed inside the water tank 100 excluding the bottom 100a, the sludge may gather at a lower portion of the water tank 100 due to gravity before getting stuck inside the water tank 100. In this case, the sludge gathered at the lower portion of the water tank 100 may be drained along with the water remaining in the water tank 100. For example, the sludge may be drained through the drain port 120 along with the water in the water tank 100.

The water tank 100 may include an inclined surface 170 formed on the lateral portion. The sludge generated due to heating by the heating device 200 may be provided to move downward along the inclined surface 170 before being stuck on an inner sidewall of the water tank 100. In this way, accumulation of the sludge can be minimized, and it can be easy to remove the sludge during cleaning of the water tank 100.

For example, the inclined surface 170 may include a first inclined surface 171 and a second inclined surface 172. The first inclined surface 171 and the second inclined surface 172 may be disposed to face each other. The first inclined surface 171 may be formed at a lower portion of the water tank 100, and the second inclined surface 172 may be formed at an upper portion of the water tank 100. However, this is only illustrative, and the present disclosure is not limited thereto. The inclined surface 170 may be provided as a single inclined surface 170 or three or more inclined surfaces 170.

The mixing chamber 500 may be disposed above the water tank 100. The mixing chamber 500 may be provided to discharge the steam generated in the water tank 100. The mixing chamber 500 may include an outlet 530 configured to discharge the steam generated in the water tank 100 to the outside of the humidifying apparatus 10. The outlet 530 may be provided at an upper end portion of the mixing chamber 500. Meanwhile, the mixing chamber 500 may be referred to as a discharge chamber 500.

The humidifying apparatus 10 may further include a guide chamber 300.

The guide chamber 300 may be disposed between the water tank 100 and the mixing chamber 500. For example, the guide chamber 300 may be disposed above the water tank 100 and below the mixing chamber 500.

The guide chamber 300 may be provided to extend from the water tank 100 to the mixing chamber 500 and allow the steam to flow. The guide chamber 300 may guide the steam generated in the water tank 100 to the mixing chamber 500.

For example, referring to FIGS. 1 and 2, the guide chamber 300 may include a first guide chamber portion 310 and a second guide chamber portion 320. The second guide chamber portion 320 may be detachably mounted on an upper portion of the first guide chamber portion 310. However, the present disclosure is not limited thereto, and the first guide chamber portion 310 and the second guide chamber portion 320 may be integrally formed. That is, the guide chamber 300 may be provided to have an integrated configuration. Alternatively, the guide chamber 300 may be provided as three or more chamber portions that are able to be coupled to each other.

The humidifying apparatus 10 may further include a fan assembly 600.

The fan assembly 600 may be provided to suction air from the outside and discharge the air into the humidifying apparatus 10. The fan assembly 600 may provide outside air to the inside of the humidifying apparatus 10. For example, the fan assembly 600 may be provided to communicate with the mixing chamber 500 and may discharge outside air to the mixing chamber 500.

The fan assembly 600 may be provided as a plurality of fan assemblies 600. Although the fan assembly 600 is illustrated in the drawings as being provided as two fan assemblies 600, the present disclosure is not limited thereto, and the fan assembly 600 may be provided as three or more fan assemblies 600. Also, the fan assembly 600 may be provided as a single fan assembly 600.

For example, the fan assembly 600 may be provided as a pair of fan assemblies 600. The pair of fan assemblies 600 may include a first fan assembly 600a and a second fan assembly 600b. The first fan assembly 600a and the second fan assembly 600b may be disposed to face each other. The first fan assembly 600a and the second fan assembly 600b may be disposed in parallel in the left-right direction (Y-direction). However, the present disclosure is not limited thereto, and the first fan assembly 600a and the second fan assembly 600b may be disposed in parallel in the front-rear direction (X-direction). A mixing tower 520 of the mixing chamber 500 may be disposed between the first fan assembly 600a and the second fan assembly 600b. Meanwhile, the positions of the fan assemblies 600 are not limited, so long as the fan assemblies 600 provide outside air to the mixing chamber 500.

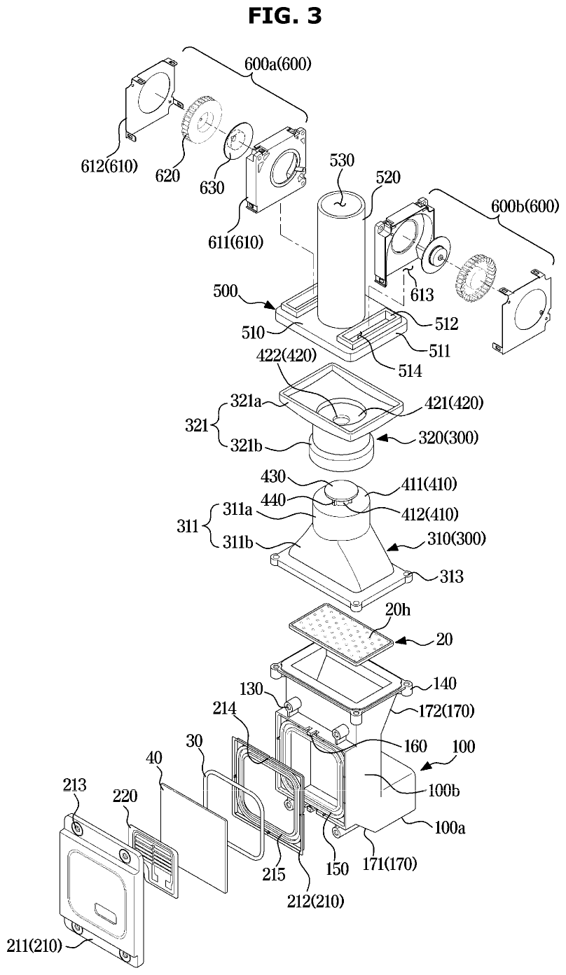

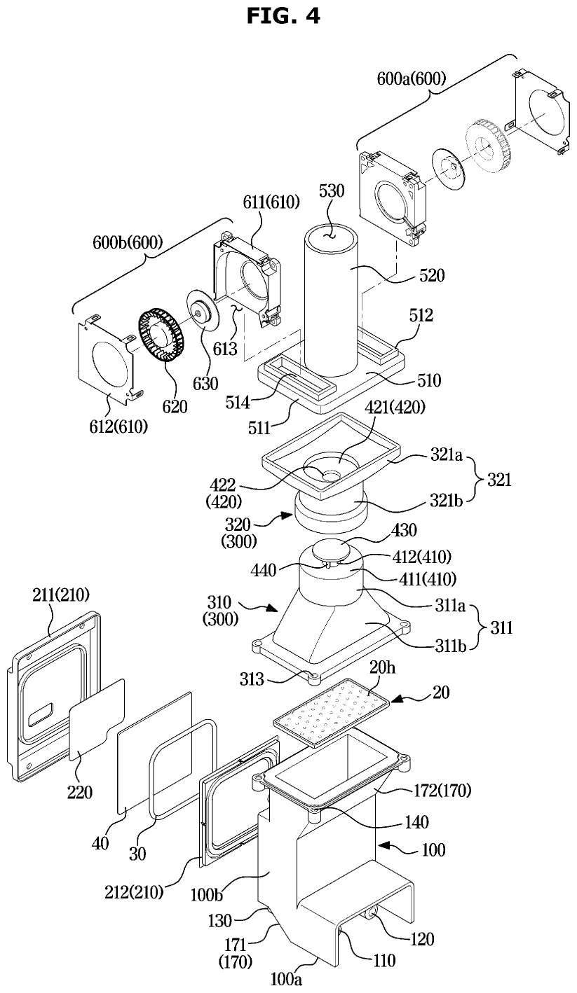

FIG. 3 is an exploded view of the humidifying apparatus according to one embodiment. FIG. 4 is an exploded view illustrating the humidifying apparatus illustrated in FIG. 3 from another direction.

The water tank 100 may be detachably coupled to the heating device 200. The heating device 200 may be detachably coupled to a portion of the water tank 100 excluding the bottom 100a. The heating device 200 may be detachably coupled to the lateral portion of the water tank 100. The heating device 200 may be detachably coupled to any sidewall 100b of the water tank 100. The heating device 200 may be detachably coupled to the inside of the water tank 100 excluding the bottom 100a.

For example, one sidewall (a counterpart) 150 of the water tank 100 on which the heating device 200 is installed may have a shape that corresponds to the shape of the heating device 200. The counterpart 150 may have a shape that corresponds to the shape of a heater case 210 which will be described below.

For example, the water tank 100 may include a case coupler 130 for coupling to the heating device 200. The case coupler 130 may be provided to be coupled to a water tank coupler 213 of the heater case 210 which will be described below.

For example, the water tank 100 may include a hook 160 to fix the heating device 200. The hook 160 may be provided to be coupled to a hook catcher 214 of the heater case 210 which will be described below.

The water tank 100 may be detachably coupled to the guide chamber 300. The water tank 100 may be detachably coupled to the first guide chamber portion 310. The first guide chamber portion 310 may be detachably coupled to an upper portion of the water tank 100.

For example, the water tank 100 may include a chamber coupler 140 for coupling to the first guide chamber portion 310. The chamber coupler 140 may be provided to be coupled to a water tank coupler 313 of the first guide chamber portion 310 which will be described below.

The water tank 100 may include the supply port 110 and the drain port 120. The supply pump 180 may be connected to the supply port 110. The drain pump 190 may be connected to the drain port 120. In this way, water may be supplied into the water tank 100, or water inside the water tank 100 may be drained. However, the present disclosure is not limited thereto, and a user may directly fill the water tank 100 with water or empty the water tank 100.

The water tank 100 may include a polypropylene (PP) material. Alternatively, the water tank 100 may include a steel material to effectively receive heat from the heating device 200. The water tank 100 may be integrally formed with a heat conduction member 40 which will be described below. However, this is only illustrative, and the water tank 100 may be provided with various other materials.

The heating device 200 may include a heater 220 and the heater case 210 provided to accommodate the heater 220.

The heater case 210 may stably fix the heater 220 to the water tank 100. The heater case 210 may prevent the heater 220 from being detached from the water tank 100.

For example, the heater case 210 may be provided as a plurality of heater cases 210. The heater cases 210 may include a first case 211 and a second case 212. The first case 211 and the second case 212 may be provided to be detachably coupled in the front-rear direction (X-direction).

The heater case 210 may include the water tank coupler 213 for coupling to the water tank 100. The water tank coupler 213 may be detachably coupled to the case coupler 130 of the water tank 100. For example, the water tank coupler 213 may be formed on the first case 211.

The heater case 210 may include the hook catcher 214 for coupling to the water tank 100. The hook catcher 214 may be provided to catch the hook 160 of the water tank 100. For example, the hook catcher 214 may be formed on the second case 212.

The heater case 210 may include a sealing member mounting portion 215. A sealing member 30 which will be described below may be mounted on the sealing member mounting portion 215. The sealing member mounting portion 215 may have a shape that corresponds to the shape of the sealing member 30. For example, the sealing member mounting portion 215 may have a substantially quadrangular frame-like shape. The sealing member mounting portion 215 may have a groove shape so that the sealing member 30 may be fitted thereto.

Meanwhile, the heater case 210 may be provided to accommodate the heat conduction member 40 which will be described below. The heater case 210 may stably fix the heat conduction member 40 to the water tank 100. The heater case 210 may prevent the heat conduction member 40 from being detached from the water tank 100.

The heat conduction member 40 may be provided between the heater 220 and the water tank 100 to transfer heat of the heater 220 to the water tank 100. The heat conduction member 40 may include a material with high thermal conductivity. For example, the heat conduction member 40 may include a steel material. However, the present disclosure is not limited thereto, and the heat conduction member 40 may include various other materials with high thermal conductivity.

The heat conduction member 40 may be provided to come in contact with the heater 220. The heat conduction member 40 may be provided to be accommodated inside the heater case 210 along with the heater 220. However, the present disclosure is not limited thereto, and, for example, the heat conduction member 40 may be integrally formed with the water tank 100. Alternatively, the heat conduction member 40 may form one sidewall of the water tank 100. Alternatively, the heat conduction member 40 may be integrally formed with the heater 220.

The heat conduction member 40 may have a substantially plate-like shape. However, the present disclosure is not limited thereto, and the heat conduction member 40 may be provided to have a shape that corresponds to the shape of the water tank 100 to be heated. For example, in a case in which the water tank 100 has a cylindrical shape, the heat conduction member 40 may have a shape that is bent to correspond to the cylindrical shape.

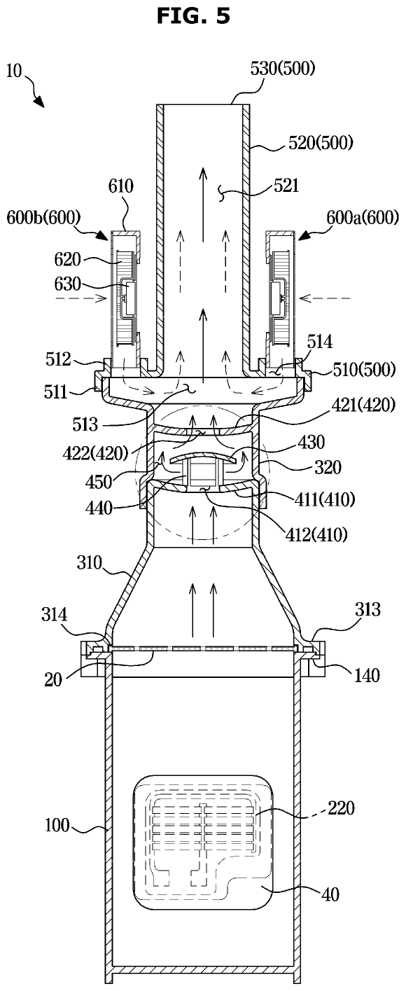

A perforated plate 20 may be provided between the water tank 100 and the guide chamber 300. The perforated plate 20 may be disposed between the water tank 100 and the first guide chamber portion 310. For example, the perforated plate 20 may be mounted on a lower side of the first guide chamber portion 310. The perforated plate 20 may be fitted to a plate mounting portion 314 of the first guide chamber portion 310 which will be described below (see FIG. 5). However, the present disclosure is not limited thereto, and the perforated plate 20 may be mounted on an upper side of the water tank 100.

As the water in the water tank 100 boils due to the heating device 200, noise due to bursting sound may be generated upon bursting of bubbles. In order to reduce such noise, the humidifying apparatus 10 may include the perforated plate 20. The noise can be reduced as the steam generated in the water tank 100 passes through a plurality of holes 20h formed in the perforated plate 20. In the process in which the steam passes through the perforated plate 20, a pressure deviation of the steam may be reduced and a temperature of the steam may be decreased, and thus the noise generated during boiling of the water can be reduced.

The guide chamber 300 may extend from the water tank 100 to the mixing chamber 500 and may guide the steam generated in the water tank 100 to the mixing chamber 500. The guide chamber 300 may extend in a direction in which the steam flows. The guide chamber 300 may extend in the vertical direction (Z-direction).

For example, the guide chamber 300 may include the first guide chamber portion 310 and the second guide chamber portion 320 disposed above the first guide chamber portion 310.

In one example, the first guide chamber portion 310 may include a first chamber body 311. The first chamber body 311 may include a first upper body 311a forming an upper exterior of the first guide chamber portion 310 and a first lower body 311b forming a lower exterior of the first guide chamber portion 310. The first upper body 311a and the first lower body 311b may be provided to have different shapes. The first upper body 311a and the first lower body 311b may be provided to have different internal cross-sectional areas. An average internal cross-sectional area of the first upper body 311a may be provided to be smaller than an average internal cross-sectional area of the first lower body 311b. The internal cross-sectional area of the first lower body 311b may be provided to progressively decrease upward.

The first guide chamber portion 310 may include the water tank coupler 313 that corresponds to the chamber coupler 140 of the water tank 100. The water tank coupler 313 may be detachably coupled to the chamber coupler 140.

The first guide chamber portion 310 may include the plate mounting portion 314 on which the perforated plate 20 may be mounted (see FIG. 5). The plate mounting portion 314 may be provided at a lower portion of the first guide chamber portion 310. The plate mounting portion 314 may have a groove shape so that the perforated plate 20 may be fitted thereto.

In one example, the second guide chamber portion 320 may include a second chamber body 321. The second chamber body 321 may include a second upper body 321a forming an upper exterior of the second guide chamber portion 320 and a second lower body 321b forming a lower exterior of the second guide chamber portion 320. The second upper body 321a and the second lower body 321b may be provided to have different shapes. The second upper body 321a and the second lower body 321b may be provided to have different internal cross-sectional areas. An average internal cross-sectional area of the second upper body 321a may be provided to be larger than an average internal cross-sectional area of the second lower body 321b. The internal cross-sectional area of the second upper body 321a may be provided to progressively increase upward.

The humidifying apparatus 10 may include a screen 430 disposed inside the guide chamber 300 and provided to guide a flow of the steam flowing inside the guide chamber 300. The humidifying apparatus 10 may include a first plate 410 disposed below and spaced apart from the screen 430 inside the guide chamber 300. The humidifying apparatus 10 may include a second plate 420 disposed above and spaced apart from the screen 430 inside the guide chamber 300. For example, the screen 430 and the first plate 410 may be provided in the first guide chamber portion 310. For example, the second plate 420 may be provided in the second guide chamber portion 320. Details thereof will be described below.

The mixing chamber 500 may include a base 510, the mixing tower 520, and the outlet 530.

The base 510 may have a lower side communicating with the water tank 100 so that the steam generated in the water tank 100 is introduced into the base 510. For example, the base 510 may communicate with the water tank 100 due to the guide chamber 300. The base 510 may have a lower side communicating with the guide chamber 300 so that the steam generated in the water tank 100 and passing through the guide chamber 300 is introduced into the base 510. For example, the base 510 may accommodate the steam from the guide chamber 300 through a steam introduction device 513 which will be described below (see FIG. 5).

The base 510 may have an upper side communicating with the fan assembly 600 so that outside air is introduced from the fan assembly 600 into the base 510. The base 510 may communicate with a discharge portion 622 of a blower fan 620. For example, the base 510 may accommodate outside air from the blower fan 620 through a communicating portion 514 which will be described below.

The base 510 may be disposed above the guide chamber 300. The base 510 may be coupled to an upper side of the second guide chamber portion 320. For example, the base 510 may include a guide chamber mounting portion 511 detachably coupled to the second guide chamber portion 320. The guide chamber mounting portion 511 may be bent downward from the base 510. The guide chamber mounting portion 511 may be coupled to cover an upper end edge of the second guide chamber portion 320.

The base 510 may include the steam introduction device 513 formed at a lower portion of the base 510 to accommodate the steam guided from the guide chamber 300 (see FIG. 5). For example, the steam introduction device 513 may be formed by the lower portion of the base 510 being open.

The base 510 may include a fan mounting portion 512 to which the fan assembly 600 is detachably coupled. In the fan mounting portion 512, the communicating portion 514 may be formed to accommodate the outside air introduced from the fan assembly 600. The communicating portion 514 may allow the mixing tower 520 and the fan assembly 600 to communicate with each other. In a state in which the fan assembly 600 is mounted on the fan mounting portion 512, the communicating portion 514 may correspond to the discharge portion 622 of the blower fan 620.

The mixing tower 520 may extend from the base 510. The mixing tower 520 may extend from the base 510 in the direction in which the steam flows. The mixing tower 520 may extend upward from the base 510. For example, the mixing tower 520 may have a hollow, substantially cylindrical shape.

The mixing tower 520 may mix the steam introduced from the guide chamber 300 and the outside air introduced from the fan assembly 600. The mixing tower 520 may form a mixing flow path 521 in which steam and the outside air are mixed. The mixing flow path 521 may longitudinally extend along an airflow so that the steam and the outside air may be sufficiently mixed.

In a case in which a high-temperature steam generated in a water tank spreads as it is to the outside of a humidifying apparatus, use stability may be decreased, and discomfort of a user may be increased. For example, in a case in which the user is directly exposed to the high-temperature steam, there is a risk of burns.

In contrast, according to one example of the humidifying apparatus 10, since the mixing chamber 500 mixes the outside air with the steam generated in the water tank 100 and discharges the mixture to the outside of the humidifying apparatus 10, use stability and satisfaction with use can be improved. For example, since the steam introduced from the guide chamber 300 into the mixing chamber 500 is mixed with the outside air while flowing along the mixing flow path 521, the steam can be effectively cooled, and the vaporization efficiency can be improved. That is, as the high-temperature steam is mixed with the outside air while flowing inside the mixing tower 520, the temperature of the steam can be decreased, and relatively large water particles included in the steam can be dried. The steam mixed with the outside air may be discharged to the outside of the humidifying apparatus 10 through the outlet 530. Thus, the risk of burns due to the high-temperature steam can be prevented, and the water particles can be prevented from splashing upward through the outlet 530.

For example, a vertical length of the mixing chamber 500 may be provided to be longer than or equal to a vertical length of the guide chamber 300. However, this is only illustrative, and the length of the mixing chamber 500 may be set to various other lengths according to the installation environment of the humidifying apparatus 10, the arrangement of internal components thereof, and the like.

The outlet 530 may be formed at an upper end portion of the mixing chamber 500 and may discharge the steam passing through the mixing flow path 521. The outlet 530 may discharge the steam mixed with the outside air while flowing along the mixing flow path 521.

The fan assembly 600 may include a fan housing 610, the blower fan 620, and a fan driving device 630. For example, each of the first fan assembly 600a and the second fan assembly 600b may include the fan housing 610, the blower fan 620, and the fan driving device 630.

The fan housing 610 may be provided to accommodate the blower fan 620 and the fan driving device 630. The fan housing 610 may guide air introduced to the blower fan 620 to the mixing chamber 500.

For example, the fan housing 610 may include a first fan housing 611 and a second fan housing 612. The first fan housing 611 and the second fan housing 612 may be detachably coupled to each other. As the first fan housing 611 and the second fan housing 612 are coupled to each other, an opening 613 may be formed. The opening 613 may be formed at a lower side of the fan housing 610 and provided to correspond to the communicating portion 514 of the mixing chamber 500. Outside air suctioned into a suction portion 621 of the blower fan 620 may be discharged to the discharge portion 622 of the blower fan 620, pass through the opening 613 and the communicating portion 514, and be introduced into the mixing chamber 500.

The blower fan 620 may be provided to force the flow of outside air. The blower fan 620 may suction the air outside the humidifying apparatus 10 and blow the suctioned air into the humidifying apparatus 10.

The blower fan 620 may include the suction portion 621 configured to suction the outside air and the discharge portion 622 configured to discharge the outside air suctioned from the suction portion 621. The discharge portion 622 of the blower fan 620 may communicate with the mixing chamber 500. The discharge portion 622 of the blower fan 620 may be provided to correspond to the communicating portion 514. For example, the blower fan 620 may be provided as a centrifugal fan configured to radially discharge air.

The fan driving device 630 may be provided to drive the blower fan 620. The fan driving device 630 may share a rotating shaft with the blower fan 620 and transfer power to the blower fan 620. For example, the fan driving device 630 may include a motor.

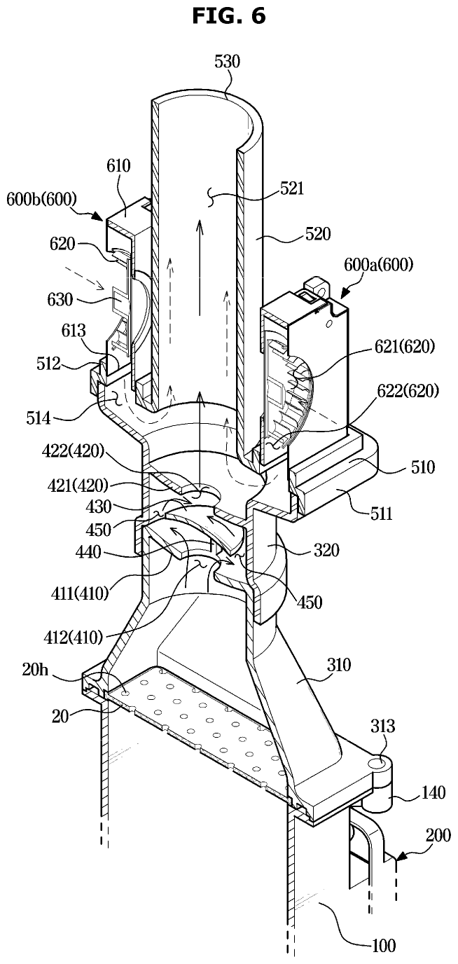

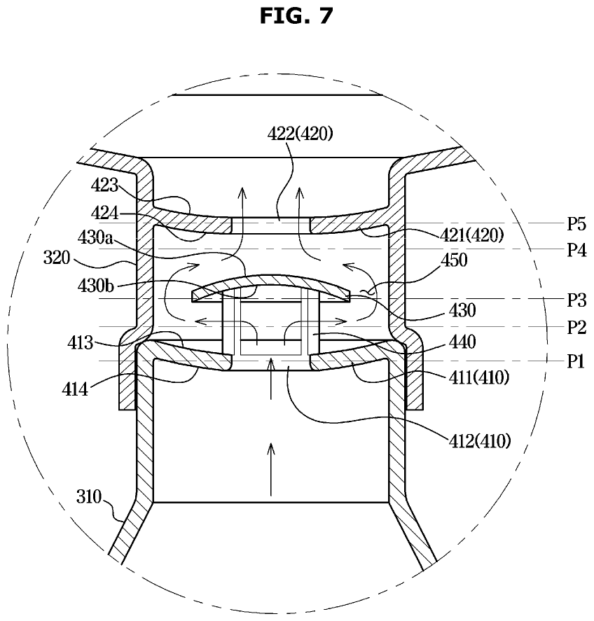

FIG. 5 is a cross-sectional view of the humidifying apparatus according to one embodiment. FIG. 6 is a view illustrating a portion cut out from the humidifying apparatus according to one embodiment. FIG. 7 is an enlarged view of a portion of the humidifying apparatus illustrated in FIG. 5.

Referring to FIGS. 5 to 7, the steam generated in the water tank 100 may pass through the guide chamber 300 and the mixing tower 520 and be discharged through the outlet 530 (see solid arrows). The outside air introduced from the fan assembly 600 may be mixed with the steam flowing in the mixing tower 520 (see broken arrows).

The screen 430 may be provided inside the guide chamber 300. The screen 430 may block a central portion inside the guide chamber 300 to interfere with the flow of the steam. The screen 430 may be provided to cover the central portion inside the guide chamber 300. The screen 430 may be provided to partition a portion of the inside of the guide chamber 300. For example, the screen 430 may be disposed in a direction that intersects with the direction in which the steam flows.

The screen 430 may be provided to change the direction in which the steam flows. The screen 430 may guide the flow of the steam so that the steam flows inside the guide chamber 300 while bypassing the screen 430.

The screen 430 may be spaced apart from an inner sidewall of the guide chamber 300 and form a gap 450 provided so that the steam passes therethrough. For example, the gap 450 may be a space provided between the inner sidewall of the guide chamber 300 and an edge of the screen 430. The gap 450 may be a space provided between an inner sidewall of the second guide chamber portion 320 and the edge of the screen 430.

Generally, in a case in which steam flows inside a chamber, for example, due to shear stress or the like of an inner sidewall of the chamber, the flow velocity of the steam may be high at a central portion of the chamber, while the flow velocity of the steam may be low at portions adjacent to the inner sidewall of the chamber. That is, the flow of the steam may be stagnated in areas of the chamber excluding the central portion thereof. Due to a flow velocity deviation of the steam, a temperature imbalance may occur and a condensation phenomenon may occur inside the chamber. Water condensed inside the chamber can cause sludge to be accumulated inside the chamber and increase a level of contamination of the inside of the chamber. Also, the water condensed inside the chamber can fall due to gravity and generate noise.

Meanwhile, as water boils in a water tank, the water may splash upward. Here, in a case in which high-temperature water particles are discharged to the outside of the humidifying apparatus, there is a risk of burns for a user. Also, in a case in which relatively large water particles are mixed in the steam and discharged to the outside of the humidifying apparatus, uniformity of moisture provided to an indoor space may be decreased, and thus the humidification efficiency can be decreased. Also, in a case in which relatively large water particles come in direct contact with the user's body or falls to a floor of the indoor space, discomfort of the user can be increased.

In contrast, according to one example, the screen 430 may be provided to block the central portion of the guide chamber 300. Accordingly, the flow of the steam at the central portion of the guide chamber 300 is interfered with by the screen 430, and thus the flow velocity of the steam may be decreased. In this way, the flow velocity of the steam flowing in the guide chamber 300 can become uniform. That is, by reducing the flow velocity deviation of the steam, the screen 430 can address the temperature imbalance and prevent the condensation phenomenon inside the guide chamber 300. Also, by suppressing the condensation of water inside the guide chamber 300, the screen 430 can prevent accumulation of sludge inside the chamber and prevent noise generated due to falling water.

Also, according to one example, the screen 430 may be provided to block water particles splashing upward as water boils in the water tank 100. For example, water particles introduced into the guide chamber 300 may be provided to collide with the screen 430 and flow downward. That is, the screen 430 can prevent relatively large water particles from being discharged through the outlet 530. For example, the screen 430 may filter the relatively large water particles. Accordingly, use stability and satisfaction with use can be improved.

The first plate 410 may be disposed below and spaced apart from the screen 430 inside the guide chamber 300. The first plate 410 may also be referred to as a lower plate 410.

The first plate 410 may be provided to interfere with the flow of the steam inside the guide chamber 300. The first plate 410 may be provided to partition a portion of the inside of the guide chamber 300.

The first plate 410 may include a first plate body 411 and a first through-hole 412 passing through the first plate body 411. The first through-hole 412 may be formed in a central portion of the first plate body 411.

The steam passing through the first through-hole 412 may be guided by the screen 430 and introduced into the gap 450. For example, the steam passing through the first through-hole 412 may flow along an upper surface 413 of the first plate 410 and a lower surface 430b of the screen 430 and be introduced into the gap 450. For example, the steam passing through the first through-hole 412 may collide with the lower surface 430b of the screen 430, and a direction of the steam may be changed to face the gap 450. Accordingly, in the process in which the steam is guided by the screen 430, the flow velocity of the steam can be decreased, and the steam can be cooled.

The second plate 420 may be disposed above and spaced apart from the screen 430 inside the guide chamber 300. The second plate 420 may also be referred to as an upper plate 420.

The second plate 420 may be provided to interfere with the flow of the steam inside the guide chamber 300. The second plate 420 may be provided to partition a portion of the inside of the guide chamber 300.

The second plate 420 may include a second plate body 421 and a second through-hole 422 passing through the second plate body 421. The second through-hole 422 may be formed in a central portion of the second plate body 421.

The steam passing through the gap 450 may be guided by the screen 430 and introduced into the second through-hole 422. For example, the steam passing through the gap 450 may flow along an upper surface 430a of the screen 430 and a lower surface 424 of the second plate 420 and be introduced into the second through-hole 422. For example, a direction of the steam passing through the gap 450 may be changed to face the second through-hole 422 due to the screen 430 and the second plate 420. Accordingly, in the process in which the steam is guided by the screen 430, the flow velocity of the steam can be decreased, and the steam can be cooled.

For example, the first plate 410, the second plate 420, and the screen 430 may be provided as separate components and provided to be coupled to the inside of the guide chamber 300. For example, at least some of the first plate 410, the second plate 420, and the screen 430 may be integrally formed with the guide chamber 300.

For example, the first guide chamber portion 310 may include the first plate 410 and the screen 430. The first guide chamber portion 310 may further include a connecting rib 440 configured to connect the first plate 410 and the screen 430. The connecting rib 440 may extend in the vertical direction. The connecting rib 440 may be provided as a plurality of connecting ribs 440, and the plurality of connecting ribs 440 may be arranged to be spaced apart from each other along an edge of the first through-hole 412. At least some of the first plate 410, the connecting rib 440, and the screen 430 may be integrally formed. At least some of the first plate 410, the connecting rib 440, and the screen 430 may be integrally formed with the first guide chamber portion 310.

For example, the second guide chamber portion 320 may include the second plate 420. The second guide chamber portion 320 may be integrally formed with the second plate 420.

One example of a steam flow will be described with reference to FIGS. 5 to 7. The steam generated in the water tank 100 may pass through the perforated plate 20. The steam passing through the perforated plate 20 may flow inside the first guide chamber portion 310 and be introduced into the first through-hole 412 of the first plate 410. Due to the screen 430, the steam introduced into the second guide chamber portion 320 through the first through-hole 412 may be prevented from flowing upward, and a direction of the steam may be changed so that the steam flows toward an inner sidewall of the guide chamber 300. For example, the steam may radially flow. The steam whose direction is changed due to the screen 430 may pass through the gap 450. The steam passing through the gap 450 may be guided by the screen 430, and a direction of the steam may be changed so that the steam flows toward a central portion of the guide chamber. The steam whose direction is changed due to the screen 430 may be introduced into the second through-hole 422 of the second plate 420. For example, the steam may flow in a winding shape. Accordingly, the steam may be provided to be cooled in the process in which the steam flows inside the guide chamber 300. The steam may be provided so that the pressure deviation of the steam is reduced in the process in which the steam flows inside the guide chamber 300. The steam introduced into the mixing chamber 500 may be provided to be mixed with outside air and cooled again. As a result, a steam with a relatively low temperature is discharged through the outlet 530, and thus the use stability of the humidifying apparatus 10 can be improved.

Meanwhile, the screen 430 may have a shape inclined downward in a direction moving away from the central portion inside the guide chamber 300 so that the screen 430 guides water flowing inside the guide chamber 300 downward. For example, the screen 430 may have a shape whose central portion is convex. In this way, the water colliding with the lower surface 430b of the screen 430 may flow downward along a slope of the lower surface 430b. The water falling to the upper surface 430a of the screen 430 may flow downward along a slope of the upper surface 430a.

The first plate 410 may have a shape inclined downward toward the first through-hole 412 in order to guide the water flowing inside the guide chamber 300 downward. For example, the first plate 410 may have a concave shape. In this way, the water flowing inside the guide chamber 300 may be guided along a slope of the first plate 410 to the first through-hole 412 formed in the central portion of the first plate 410. The water falling to the upper surface 413 of the first plate 410 may be guided along a slope of the upper surface 413 of the first plate 410 to the first through-hole 412.

The second plate 420 may have a shape inclined downward toward the second through-hole 422 in order to guide the water flowing inside the guide chamber 300 downward. For example, the second plate 420 may have a concave shape. In this way, the water flowing inside the guide chamber 300 may be guided along a slope of the second plate 420 to the second through-hole 422 formed in the central portion of the second plate 420. The water falling to an upper surface 423 of the second plate 420 may be guided along a slope of the upper surface 423 of the second plate 420 to the second through-hole 422.

An internal cross-sectional area of the guide chamber 300 may be provided to be changed in the direction in which the steam flows. The internal cross-sectional area of the guide chamber 300 may be provided to be changed in the vertical direction (Z-direction) so that the size of the internal cross-section is non-uniform. For example, the internal cross-section of the guide chamber in a direction of the flow of the steam can get progressively larger, progressively smaller, progressively larger up to a point and then progressively smaller, progressively smaller up to a point and then progressively larger, etc. However, embodiments are not limited to this specific example. Here, the internal cross-sectional area may refer to a cross-sectional area of an area through which the steam passes.

A pressure of the steam flowing in the guide chamber 300 may be changed according to the internal cross-sectional area. In a case in which the internal cross-sectional area of the guide chamber 300 is small, the pressure of the steam may be high. In a case in which the internal cross-sectional area of the guide chamber 300 is large, the pressure of the steam may be low. The pressure of the steam may increase or decrease while the steam flows in the guide chamber 300. The increase and decrease of the pressure of the steam may repeatedly occur while the steam flows in the guide chamber 300. Accordingly, the pressure deviation of the steam can be reduced to reduce noise. Also, the temperature inside the guide chamber 300 can be made uniform to prevent the condensation phenomenon.

For example, the first lower body 311b of the first guide chamber portion 310 may have a shape in which an internal cross-sectional area progressively decreases upward. The second upper body 321a of the second guide chamber portion 320 may have a shape in which an internal cross-sectional area progressively increases upward.

For example, as the screen 430, the first plate 410, and the second plate 420 are provided inside the guide chamber 300, the internal cross-sectional area of the guide chamber 300 may be provided to be changed. The internal cross-sectional area of the guide chamber 300 may be decreased and increased repeatedly.

Referring to FIG. 7, an internal cross-sectional area of a point P1 at which the first through-hole 412 is provided may be smaller than an internal cross-sectional area of a point P2 between the first plate 410 and the screen 430. The internal cross-sectional area of the point P2 between the first plate 410 and the screen 430 may be larger than an internal cross-sectional area of a point P3 at which the screen 430 is provided. The internal cross-sectional area of the point P3 at which the screen 430 is provided may be smaller than an internal cross-sectional area of a point P4 between the screen 430 and the second plate 420. The internal cross-sectional area of the point P4 between the screen 430 and the second plate 420 may be larger than an internal cross-sectional area of a point P5 at which the second through-hole 422 is provided.

For example, the size of the screen 430 may be larger than the size of the first through-hole 412. A diameter of the screen 430 may be larger than a diameter of the first through-hole 412. In this way, the steam passing through the first through-hole 412 may be prevented from recirculating and flowing back to the first through-hole 412. Also, the steam passing through the first through-hole 412 may be effectively guided by the upper surface 413 of the first plate 410 and the lower surface 430b of the screen 430.

For example, the size of the screen 430 may be larger than the size of the second through-hole 422. The diameter of the screen 430 may be larger than a diameter of the second through-hole 422. In this way, the steam passing through the second through-hole 422 may be prevented from recirculating and flowing back to the second through-hole 422. Also, the steam passing through the second through-hole 422 may be effectively guided by the lower surface 424 of the second plate 420 and the upper surface 430a of the screen 430.

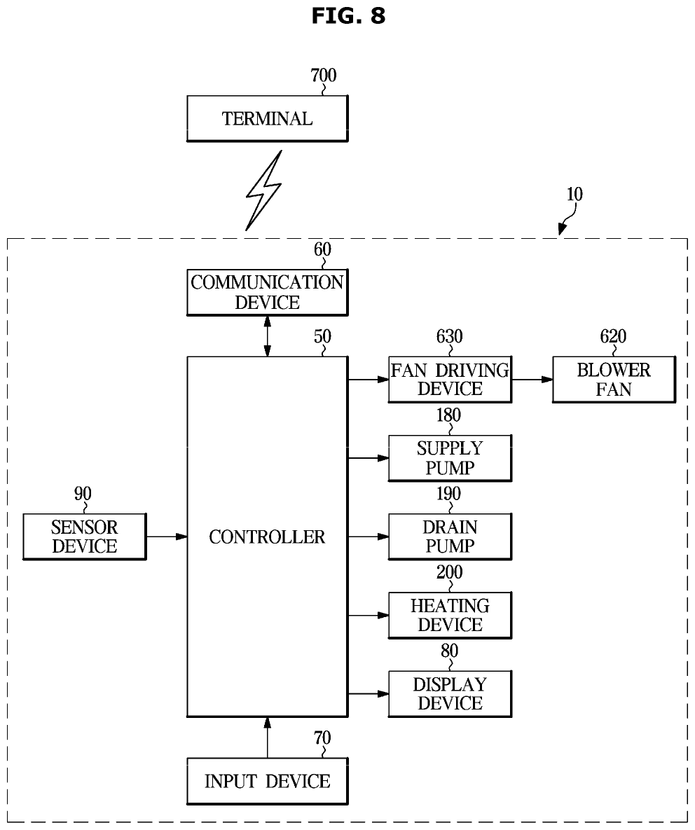

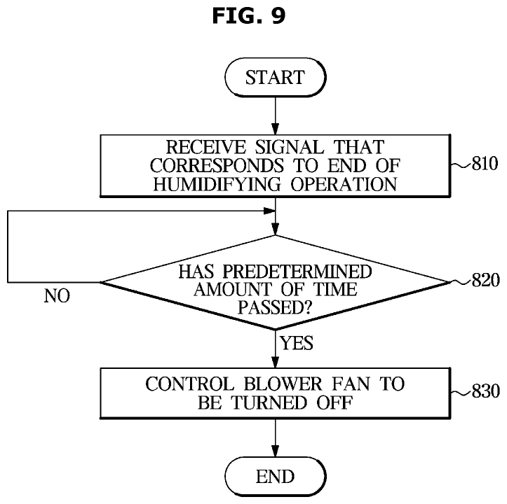

FIG. 8 is a control block diagram of the humidifying apparatus according to one embodiment. FIG. 9 is a flowchart of an example of a method of controlling the humidifying apparatus according to one embodiment.

Referring to FIG. 8, the humidifying apparatus 10 according to one embodiment may include a sensor device 90, a controller 50, a communication device 60, an input device 70, and a display device 80. However, any of the components of the humidifying apparatus 10 illustrated in FIG. 8 may be omitted according to embodiments, and other components not illustrated in FIG. 8 may also be included according to embodiments.

The sensor device 90 may detect various states of the humidifying apparatus 10.

For example, the sensor device 90 may include a moisture sensor configured to detect moisture inside the humidifying apparatus 10. The moisture sensor may transmit information on the moisture detected from inside the humidifying apparatus 10 to the controller 50.

For example, the sensor device 90 may include a water level sensor configured to detect a water level in the water tank 100 of the humidifying apparatus 10. The water level sensor may transmit information on the water level detected from the water tank 100 of the humidifying apparatus 10 to the controller 50.

The communication device 60 may perform communication with a user terminal 700 (e.g., a mobile phone, a tablet, a PC, or the like). The input device 70 may receive a user command. The input device 70 may transmit information input by the user to the controller 50. The display device 80 may display various states and operation information of the humidifying apparatus 10.

The controller 50 may be provided to control the operation of each of the fan driving device 630, the supply pump 180, the drain pump 190, the heating device 200, and the display device 80.

For example, in a case in which the moisture inside the humidifying apparatus 10 exceeds a certain level, foreign matter such as sludge may be stuck inside the humidifying apparatus 10. In order to prevent this, the controller 50 may control the fan driving device 630 according to the moisture information received from the moisture sensor. In a case in which the moisture detected by the moisture sensor exceeds moisture in a predetermined range, the controller 50 may control the fan driving device 630 to turn on the blower fan 620.

For example, the controller 50 may control the fan driving device 630 so that the blower fan 620 is turned off after passage of a predetermined amount of time upon an end of a humidifying operation instead of the operation of the blower fan 620 immediately ending upon the end of the humidifying operation. That is, the blower fan 620 may be provided to be turned off after passage of a predetermined amount of time upon the end of the humidifying operation.

For example, in a case in which the water level in the water tank 100 is lower than a water level in a predetermined range, the controller 50 may control the supply pump 180 so that water is supplied into the water tank 100. In a case in which the water level in the water tank 100 exceeds the water level in the predetermined range, the controller 50 may control the drain pump 190 so that the water in the water tank 100 is drained. Meanwhile, the controller 50 may control the supply pump 180 so that water is supplied into the water tank 100 upon a start of the humidifying operation. The controller 50 may control the drain pump 190 so that the water in the water tank 100 is drained upon the end of the humidifying operation.

For example, the controller 50 may control the heating device 200 to be turned on upon the start of the humidifying operation and may control the heating device 200 to be turned off upon the end of the humidifying operation.

Referring to FIG. 9, the humidifying apparatus 10 may receive a signal that corresponds to the end of the humidifying operation (810). For example, the controller 50 may receive from the input device 70 a user input requesting to end the humidifying operation. The humidifying apparatus 10 may determine whether a predetermined amount of time has passed after the end of the humidifying operation (820). The blower fan 620 may be turned off after passage of the predetermined amount of time. For example, the controller 50 may control an on/off function of the blower fan 620 through the fan driving device 630.

Meanwhile, the humidifying apparatus 10 described above may be applied to various domestic appliances. For example, the domestic appliance may include at least one of a humidifier, an indoor unit, an air cleaner, and a steam closet. However, this is only illustrative, and the humidifying apparatus 10 may be applied to any other domestic appliance as long as the domestic appliance is designed to request a humidifying operation. The type of domestic appliance is not limited.

The domestic appliance may include a main body, an outside air inlet, and a steam outlet.

The humidifying apparatus 10 may be provided in the main body. The main body may be provided to accommodate the humidifying apparatus 10. The main body may accommodate components other than the humidifying apparatus 10.

The outside air inlet may be provided so that air is introduced from the outside. The outside air inlet may be disposed to correspond to the fan assembly 600. The outside air inlet may be provided to communicate with the blower fan 620. For example, the outside air inlet may be formed in a lateral portion of the main body.

The steam outlet may be provided so that the steam generated in the humidifying apparatus 10 is discharged to the outside. The steam outlet may be disposed to correspond to the outlet 530 of the mixing chamber 500. The steam mixed with the outside air in the mixing tower 520 may be discharged to the outside through the outlet 530 and the steam outlet. For example, the steam outlet may be formed in an upper portion of the main body.

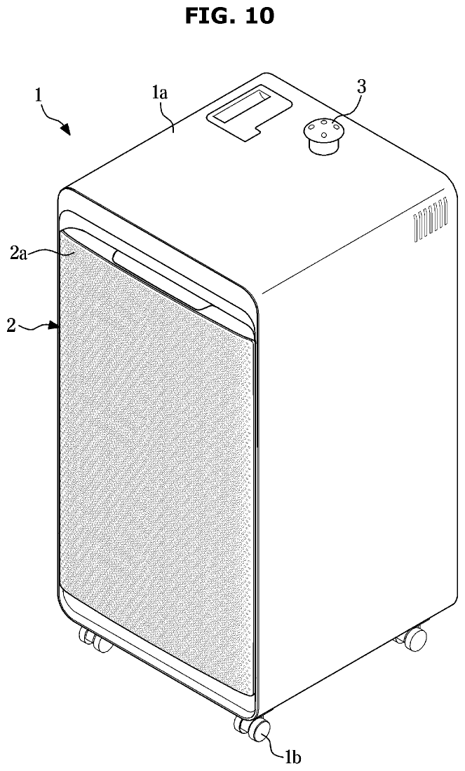

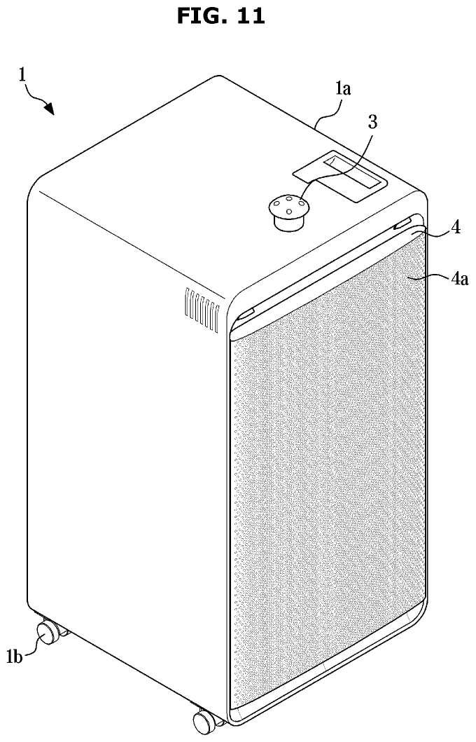

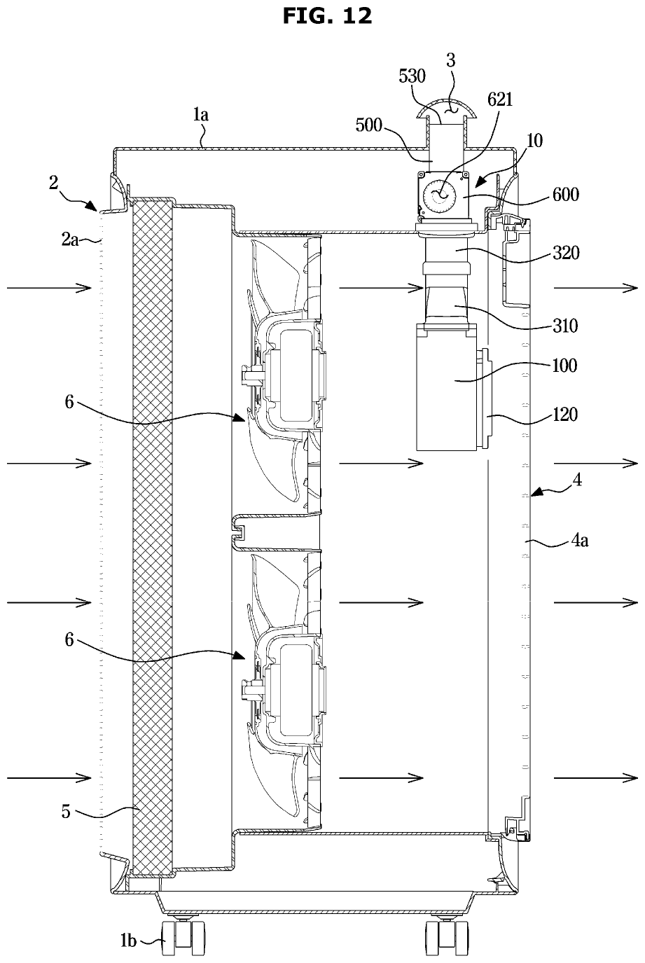

FIG. 10 is a perspective view of an example of an air cleaner including the humidifying apparatus according to one embodiment. FIG. 11 is a rear perspective view of the air cleaner illustrated in FIG. 10. FIG. 12 is a cross-sectional view of the air cleaner illustrated in FIG. 10.

With reference to FIGS. 10 to 12, an air cleaner 1 will be described as an example of a domestic appliance including the humidifying apparatus 10.

As illustrated in FIGS. 10 to 12, the air cleaner 1 may include a main body 1a. The main body 1a may form an exterior of the air cleaner 1. For example, the main body 1a may have a substantially box-like shape. Wheels 1b may be provided at a lower portion of the main body 1a for free movement of the air cleaner 1.

The humidifying apparatus 10 configured to generate a steam may be accommodated inside the main body 1a.

The main body 1a may include a suction panel 2 provided to suction outside air. The main body 1a may include a discharge panel 4 provided to discharge air purified inside the air cleaner. For example, the suction panel 2 may be provided at a first side of the main body 1a, and the discharge panel 4 may be provided at a second side which is an opposite side of the first side.

For example, the suction panel 2 may be the outside air inlet of the domestic appliance described above.

For example, the suction panel 2 may include a plurality of suction holes 2a. However, the present disclosure is not limited thereto, and the suction panel 2 may include a suction grille.

For example, the discharge panel 4 may include a plurality of discharge holes 4a. However, the present disclosure is not limited thereto, and the discharge panel 4 may include a discharge grille.

The air cleaner 1 may include a filter member 5 provided to purify the outside air suctioned from the suction panel 2. The filter member 5 may be provided to filter foreign matter in air introduced into the air cleaner 1.

The air cleaner 1 may include a fan 6 configured to force air to blow. The fan 6 may cause outside air to be introduced into the main body 1a of the air cleaner 1 or cause purified air to be discharged to the outside of the main body 1a of the air cleaner 1. Although the fan 6 is illustrated as being provided as two fans 6 in FIG. 12, the present disclosure is not limited thereto, and the fan 6 may be provided as a single fan 6 or three or more fans 6. Also, in a case in which the fan 6 is provided as a plurality of fans 6, although the plurality of fans 6 are illustrated as being arranged in the vertical direction in FIG. 12, the present disclosure is not limited thereto, and the plurality of fans 6 may also be arranged in the front-rear direction or left-right direction. For example, the fan 6 may be disposed behind the filter member 5.

The main body 1a may include a steam outlet 3 provided so that the steam generated in the humidifying apparatus 10 is discharged to the outside. The steam outlet 3 may be provided to communicate with the outlet 530 of the humidifying apparatus 10. The steam outlet 3 may be provided to correspond to the outlet 530 of the humidifying apparatus 10. For example, the humidifying apparatus 10 may be disposed behind the fan 6.

Although the steam outlet 3 is illustrated as having a shape that protrudes upward from the main body 1a in FIGS. 10 to 12, the present disclosure is not limited thereto. For example, the steam outlet 3 may have a shape that passes through a portion of an upper side of the main body 1a.

One example of a flow of air of the air cleaner will be described with reference to FIG. 12.

Referring to FIG. 12, the filter member 5, the fans 6, and the humidifying apparatus 10 may be arranged along the flow of air (see arrows). Due to a blowing force of the fans 6, air suctioned into the main body 1a through the suction holes 2a of the suction panel 2 may pass through the filter member 5 and may be filtered. The air passing through the filter member 5 may be discharged toward a discharge side of the fans 6 and may be discharged to the outside of the main body 1a through the discharge holes 4a of the discharge panel 4. Meanwhile, some of the air passing through the filter member 5 (or some of the air passing through the filter member 5 and the fans 6) may be introduced into the suction portion 621 of the blower fan 620 of the humidifying apparatus 10. The air introduced into the suction portion 621 may be mixed with a high-temperature steam in the mixing tower 520. As a result, the steam whose temperature is relatively lowered due to being mixed with the air introduced into the suction portion 621 may flow upward and be discharged through the outlet 530. The steam discharged through the outlet 530 may be discharged to the outside of the main body 1a of the air cleaner 1 through the steam outlet 3. That is, the air cleaner 1 may perform a humidifying operation.

According to the example described above, the blower fan 620 of the humidifying apparatus 10 may be provided to suction air that is purified due to passing through the filter member 5. That is, the high-temperature steam generated in the water tank 100 of the humidifying apparatus 10 may be mixed with the purified air. In this way, contamination of the fan assembly 600 and the mixing chamber 500 can be reduced, and a cleaning cycle of the humidifying apparatus 10 can also be extended. However, this is only an example, and the shape and arrangement of the humidifying apparatus 10 are not limited to those in the illustrated example.

Meanwhile, as described above, the domestic appliance to which the humidifying apparatus 10 is applied is not limited to the air cleaner. For example, the humidifying apparatus 10 may also be provided in an indoor unit of an air conditioner. In one example, an indoor unit of an air conditioner may be implemented in a form in which a heat exchanger is further provided inside the main body 1a illustrated in FIGS. 10 to 12.

According to one aspect of the present disclosure, a humidifying apparatus can have a structure with improved use stability.

According to another aspect of the present disclosure, a humidifying apparatus can prevent accumulation of sludge in a water tank.

According to still another aspect of the present disclosure, a humidifying apparatus can reduce noise generated during heating of water accommodated in a water tank.

Specific embodiments illustrated in the drawings have been described above. However, the present disclosure is not limited to the embodiments described above, and those of ordinary skill in the art to which the disclosure pertains may make various changes thereto without departing from the gist of the technical spirit of the disclosure defined in the claims below.

What is claimed is:

1. A humidifying apparatus comprising:
a water tank configured to hold water;
a heating device configured to heat the water held in the water tank;
a discharge chamber disposed above the water tank and including an outlet configured to discharge steam generated in the water tank due to the water being heated by the heating device;
a guide chamber between the water tank and the discharge chamber and configured to guide the steam generated in the water tank into the discharge chamber; and
a screen at a central portion of an inside of the guide chamber and spaced apart from an inner sidewall of the guide chamber to form a gap between the screen and the inner sidewall, so that the screen interferes with a flow of the steam guided by the guide chamber in the central portion and allows the steam guided by the guide chamber to flow through the gap and to then be guided by the guide chamber into the discharge chamber.

2. The humidifying apparatus of claim 1, further comprising:
a lower plate inside the guide chamber disposed below and spaced apart from the screen and including a through-hole in a central portion of the lower plate so that the steam guided by the guide chamber passes through the through-hole and then into the gap.

3. The humidifying apparatus of claim 1, further comprising:
an upper plate inside the guide chamber disposed above and spaced apart from the screen and including a through-hole in a central portion of the upper plate so that the steam, after flowing through the gap, is guided by the upper plate to flow through the through-hole and then into the discharge chamber.

4. The humidifying apparatus of claim 1, further comprising:
a blower fan including a suction portion configured to suction outside air and a discharge portion communicating with the discharge chamber to deliver the outside air suctioned by the suction portion to the discharge chamber.

5. The humidifying apparatus of claim 4, wherein the discharge chamber further includes:
a base detachably coupled to an upper portion of the guide chamber; and
a mixing tower extending from the base in a direction in which the steam flows and that is configured to mix the steam introduced from the guide chamber and the outside air introduced from the blower fan.

6. The humidifying apparatus of claim 1, wherein the screen is inclined downward and away from the central portion of the guide chamber so that condensed water from the steam flowing inside the guide chamber is guided downward and away from the discharge chamber.

7. The humidifying apparatus of claim 2, wherein the lower plate is inclined downward and toward the through-hole so that condensed water from the steam flowing inside the guide chamber is guided downward by the lower plate and away from the discharge chamber.

8. The humidifying apparatus of claim 3, wherein the upper plate is inclined downward and toward the through-hole so that condensed water from the steam flowing inside the guide chamber is guided downward by the upper plate and away from the discharge chamber.

9. The humidifying apparatus of claim 4, wherein the blower fan is configured to turn off after passage of a predetermined amount of time after a humidifying operation by the humidifying apparatus ends.

10. The humidifying apparatus of claim 5, wherein:
the blower fan further includes a first blower fan and a second blower fan; and
the mixing tower of the discharge chamber is disposed between the first blower fan and the second blower fan.

11. The humidifying apparatus of claim 1, further comprising:
a perforated plate disposed between the guide chamber and the water tank so that noise generated when the heating device heats the water held in the water tank is attenuated.

12. The humidifying apparatus of claim 1, wherein a size of an internal cross-sectional area of the guide chamber in a direction in which the steam flows is non-uniform so that a pressure of the steam that is guided through the guide chamber is changed relative to a previous pressure of the steam.

13. The humidifying apparatus of claim 1, further comprising:
a first plate disposed below and spaced apart from the screen inside the guide chamber and including a first through-hole in a central portion of the first plate; and
a second plate disposed above and spaced apart from the screen inside the guide chamber and including a second through-hole in a central portion of the second plate,
wherein the guide chamber further includes:
a first guide chamber portion detachably coupled to an upper side of the water tank that includes the first plate, the screen, and a connecting rib configured to connect the first plate to the screen, and
a second guide chamber portion detachably coupled to an upper side of the first guide chamber portion to communicate with the discharge chamber and that includes the second plate.

14. The humidifying apparatus of claim 1, wherein:
the water tank includes a bottom and a sidewall extending upward from the bottom; and
the heating device is disposed on the sidewall of the water tank.

15. The humidifying apparatus of claim 1, further comprising:
a supply pump connected to the water tank to supply water to the water tank; and
a drain pump connected to the water tank to drain the water held in the water tank.
